(19) United States
(12) Patent Application Publication
(10) Pub. No.: US 2011/0258929 A1
(43) Pub. Date: Oct. 27, 2011

(54) Improvement to Wall-Mounted Set of Ornamental Plant Pots

(76) Inventor: Gislene Medeiros Mesiara, Sao Paulo (BR)

(21) Appl. No.: 13/129,761

(22) PCT Filed: Aug. 14, 2009
(86) PCT No.: PCT/BR2009/000268

§ 371 Date: May 17, 2011

(30) Foreign Application Priority Data
Nov. 13, 2008 (BR) MU-8.802.729-5

(51) Int. Cl. A01G 9/02

(52) U.S. Cl. 47/83

(57) ABSTRACT

THE PRESENT INVENTION REFERS TO A VERTICAL GARDEN ASSEMBLY, CONCERNED WITH THE FIELD OF GARDENING, MORE PRECISELY FOR USE IN THE DECORATION OF INTERNAL AND EXTERNAL ENVIRONMENTS BY MEANS OF ADEQUATELY SUSPENDED VASES, TO WHICH AN ORIGINAL CONSTRUCTIVE ARRANGEMENT IS GIVEN, AIMING TO REACH A DIFFERENT FUNCTIONAL OPTION FROM THE MODELS PREVIOUSLY DEVELOPED BY THE INVENTOR.

THE PRESENT INVENTION REFERS TO A VERTICAL GARDEN ASSEMBLY, CONCERNED WITH THE FIELD OF GARDENING, MORE PRECISELY FOR USE IN THE DECORATION OF INTERNAL AND EXTERNAL ENVIRONMENTS BY MEANS OF ADEQUATELY SUSPENDED VASES, TO WHICH AN ORIGINAL CONSTRUCTIVE ARRANGEMENT IS GIVEN, AIMING TO REACH A DIFFERENT FUNCTIONAL OPTION FROM THE MODELS PREVIOUSLY DEVELOPED BY THE INVENTOR.

THIS IS A COMPLEMENTARY LANDSCAPE SOLUTION FOR VERTICAL

GARDENS, ALLOWING THE SAFE AND FUNCTIONAL HANGING SUSPENSION OF VASES FOR PLANTS IN A WIDE RANGE OF SHAPES AND TYPES.

THEREFORE, THE PRESENT INVENTION IS AN IMPROVEMENT, ESPECIALLY DESIGNED AND DEVELOPED TO REACH A WIDELY PRACTICAL SOLUTION BRINGING IN A RANGE OF ADVANTAGES, BOTH IN ITS USE AND MANUFACTURE, NOT REQUIRING ANY KNOWLEDGE BEYOND ALREADY EXISTING GARDENING SKILLS FOR THE USE OF THE PRESENT ARRANGEMENT, SINCE PLANTS, AS PLANTED IN THE VASES CONNECTED TO THE SUPPORT, MAY BE VERTICALLY LOCATED ON WALLS, NOT REQUIRING THE USE OF CHAINS OR APPARENT METAL STRUCTURES.

ANOTHER OBJECT OF THE PRESENT PATENT IS AN IMPROVEMENT APPLIED TO AN ASSEMBLY FOR VERTICAL GARDENS WITH LOW COST FOR ITS INDUSTRIAL VIABILITY, ALLIED TO THE REQUIREMENTS OF STRENGTH, SAFETY AND PRACTICAL USE, THUS OFFERING THE CONSUMER AN ADDITIONAL OPTION IN THE MARKET THAT PRESENTS SIMILAR PRODUCTS.

MOST HOUSES, OFFICES AND STORES ARE CURRENTLY ORNAMENTED WITH SOME KIND OF PLANT OR NATURAL FOLIAGE, SO AS TO OFFER PEACEFULNESS AND NATURALNESS TO INTERNAL OR EXTERNAL ENVIRONMENTS.

AS KNOWN, ESPECIALLY BY LANDSCAPERS AND DECORATORS, THE

MOST WIDELY USED AND PREFERRED MODEL TO ARRANGE PLANTS IN SUCH ENVIRONMENTS IS A SUSPENDING SUPPORT, ESPECIALLY TO KEEP THE FLOOR AREA FREE FOR TRANSIT.

ORNAMENTAL PLANTS ARE PUT IN VASES MADE OF CERTAIN TREE FERNS OR CLAY CONTAINING SOIL, WHICH ARE LATER HOUSED IN

SUPPORTS, GENERALLY A PLASTIC BASE SIMILAR TO A “PLATE WITH WINGS”, FROM WHICH SIDE CHAINS ARE JOINED TO A RING, WHICH IS THEN HUNG TO HOOK AT THE END OF A SHAFT.

ONE OF THE MAIN INCONVENIENCES OF SAID MODELS IS, FIRST OF ALL, THE FACT THAT MOST VASES AND DEVICES INCONVENIENTLY OCCUPY USEFUL SPACES IN CORRIDORS, ROOMS AND OTHERS, FREQUENTLY WITH LIMITATIONS IN THEIR FREE SPACE.

FURTHERMORE, MOST DEVICES REQUIRE WATER RESERVOIRS, WHICH HAVE BECOME A PUBLIC HEALTH PROBLEM FOR CREATING A FAVORABLE ENVIRONMENT TO THE APPEARANCE OF DENGUE MOSQUITO LARVAE AND OFFERING EASY ACCESS AND A FAVORABLE ENVIRONMENT TO THE REPRODUCTION OF DIPTERANS.

FURTHERMORE, IT IS COMMON SENSE THAT THE USE OF ORNAMENTAL PLANTS AND THEIR AESTHETICALLY IMPRESSION TO DECORATIVE TRENDS SHOULD NOT BE SUPPRESSED.

FROM THE ABOVE VERIFICATIONS, THE INVENTOR HAS DEVELOPED A SUPPORT FOR PLANTS, WHOSE CONSTRUCTIVE ARRANGEMENT IS APPLIED TO A VERTICAL STRUCTURE, FIXED IN PLACE BY MEANS OF A SCREWED SUPPORT, OPTIONALLY BEING PERIPHERALLY AND ORTHOGONALLY PROVIDED WITH PROJECTING LATERALS (WITH RELATION TO THE VERTICAL STRUCTURE), RECTANGULAR ON ITS FRONT SIDE, CIRCULAR OR WITH ANOTHER GEOMETRICALLY REGULAR OR IRREGULAR SHAPE AS MORE APPROPRIATE TO THE SPACE WHERE IT IS INTRODUCED, WITH THE VERTICAL FLAT STRUCTURE CONTAINING A FRAME OVER THE PERIMETER OF THE PROJECTING LATERAL.

SAID DISPOSITION WAS ORIGINALLY DEVELOPED INCORPORATING AN AUTOMATIC IRRIGATION SYSTEM BY MEANS OF A PRESSURE PUMP INSTALLED WITHIN A FRAME, SO AS TO PROVIDE THE FALL OF WATER THROUGHOUT A FIBER PANEL THAT CONTAINED THE PLANTS. SAID DISPOSITION ELIMINATED THE NEED TO MANUALLY WATER THE PLANTS.

HOWEVER, CONCERNING ARRANGEMENTS IN THE FORM OF VASES, PLASTIC BASE SUPPORTS SUSPENDED BY CHAINS ARE STILL USED AND, BESIDES THEIR UGLY APPEARANCE, THEY DO NOT ALLOW A DIFFERENT AND MORE VERSATILE ARRANGEMENT OF THE PLANTS WITHOUT THE INCONVENIENT AND TROUBLESOME USE OF VARIOUS KINDS OF SUPPORTS.

FROM THE PERCEPTION OF THIS NEED, THE INVENTOR WENT THROUGH THE DEVELOPMENT OF OTHER SUPPORTS FOR PLANTS, APPLICABLE TO A VERTICAL FLAT STRUCTURE, INTERNALLY PROVIDED WITH A PLATE, WIRE NET OR EVEN SCREEN, EVOLVING TO AN ASSEMBLY PROVIDED WITH OTHER IMPROVEMENTS TO SOLVE A FEW LIMITATIONS, AMONG WHICH CAN BE HIGHLIGHTED: THE NEED TO SAFELY LOCK THE VASE TO THE SUPPORT, THE POSSIBILITY TO INSTALL THE SUPPORTS IN MODULES, TO FIX THE SUPPORT WITH A GIVEN DISTANCE FROM THE WALL, AMONG OTHERS.

THEREFROM, THE INVENTOR, AIMING TO IMPROVE VERTICAL GARDEN ARRANGEMENTS AND BETTER MEET THE DIFFERENT REQUIREMENTS AND DEMANDS TO MAKE VERTICAL GARDENS, HAS DEVELOPED THE PRESENT VERTICAL ASSEMBLY FOR GARDENS, CONCEIVED FROM THE CONSTRUCTION OF A SUPPORT IN THE SHAPE OF A QUADRANGULAR SCREEN, PREFERABLY FROM RIGID MARITIME GRADE ALUMINUM WIRES, WHICH ARE INTERTWINED OR WELDED, AND WITH BLACK ELECTROSTATIC COVERING, AT WHOSE VERTEXES PERFORATED “L” SHAPED PROJECTIONS ARE PROVIDED WITH APPROPRIATE SPACING TO FIX THE SUPPORT TO WALLS AND PANELS, BY MEANS OF STAINLESS STEEL SCREWS. SAID SPACING AIMS TO AVOID THE OCCURRENCE PROJECTIONS AND DRIPPING OF WATER DIRECTLY TO THE WALL, CAUSING UNDESIRED INFILTRATIONS.

ON THE WIRES ONE HANGS VARIOUS TRAPEZOIDAL/ELLIPSOIDAL VASES, PREFERABLY OF POLYMER CONTAINING BLACK PIGMENT AND WITH A GRADE OF PROTECTION AGAINST UVA AND UVB RAYS, PROVIDED ON THEIR BACK PART WITH “L” SHAPED WINGS WITH ONE OR TWO LOCKING PROJECTIONS, ABLE TO FIT INTO THE BACK SCREEN AND KEEP THE VASES COMPLETELY STABLE AND FIXED AGAINST THE OCCURRENCE OF WINDS.

THEREFORE, THE USER MAY PLACE AND REMOVE THE VASES FROM THE BACK SCREEN WITH NO NEED TO RELEASE ANY KIND OF FIXING ELEMENT. IN OTHER PARTICULAR ASPECT, THE PRESENT ARRANGEMENT ALLOWS FIXING THE VASES SO AS TO KEEP THEM FROM BEING TAKEN BY THIEVES OR VANDALS, WHEN INSTALLED IN PLACES WITH FREE PUBLIC ACCESS. FURTHERMORE, THE MAINTENANCE OF PLANTS IS EASILY PERFORMED, SINCE IT DOES NOT REQUIRE THE BACK PLATE, NOR ALL VASES AT THE SAME TIME TO BE TAKEN OFF THE WALL. IT IS OPTIONAL TO USE AN AUTOMATED IRRIGATION SYSTEM TO MAKE THE IRRIGATION OF THE PLANTS EASIER.

THE INVENTOR HAS ADOPTED, WITH NO LIMITATION TO ONLY THIS ALTERNATIVE, THE BLACK COLOR FOR ELEMENTS FORMING THE ASSEMBLY AND ALSO AS A BACKGROUND COLOR FOR THE SURFACES COVERED BY THE VERTICAL GARDEN, TO CREATE THE AESTHETICAL EFFECT OF AN INFINITE BACKGROUND. THIS DETAIL IS IMPORTANT WHEN THE VERTICAL GARDEN IS IN USE, WHEN POSSIBLE FAILURE IN VEGETATION COVERAGE CANNOT BE EASILY SEEN. IT IS ALSO IMPORTANT TO REMARK THAT THE INVENTOR HAS ADOPTED AS PREFERABLE MATERIALS WHICH ARE NOT PERISHABLE AND ARE RESISTANT TO WEATHER CONDITIONS, SUCH AS MARITIME GRADE ALUMINUM WITH BLACK ELECTROSTATIC COVERING AND PLASTIC WITH UVA AND UVB PROTECTION AIMING TO REACH LONGER USE OF THE ASSEMBLY. ANOTHER ADVANTAGE OF THE PRESENT INVENTION REFERS TO THE EASY DISASSEMBLY AND RE-ASSEMBLY OF THE STRUCTURE, WHICH IS A NOVEL CONDITION IN THE CONCEPTION OF VERTICAL GARDENS, OFFERING COST SAVINGS AND PRACTICAL USE TO THE CONSUMER, WHO CAN RE-USE ALL PARTS OF THE VASE ARRANGEMENT. ON THE OTHER HAND, VASE MOBILITY ALLOWS CREATING VARIOUS GEOMETRICAL PATTERNS, NOT REQUIRING THE VASES TO BE SYMMETRICALLY DISTRIBUTED, SINCE THE BACK SCREEN ALLOWS THE FREE MOVEMENT OF THE VASE “L” SHAPED WINGS ALONG VARIOUS POINTS ON THE SCREEN.

FURTHERMORE, THE PRESENT ARRANGEMENT ALLOWS THE USE OF A WATER DEVIATION ELEMENT COUPLED TO THE BOTTOM OF THE VASE, KEEPING THE WATER PERCOLATED THROUGH THE VASE HOLES FROM BEING DIRECTED TO INSIDE OF THE SUBSEQUENT VASE. THIS DETAIL MATTERS IN CASES WHERE PLANTS WITH DIFFERENT WATER REQUIREMENTS ARE USED, I. E. TO AVOID THE WATER PERCOLATED FROM VASES WITH PLANTS WHICH ARE MORE FREQUENTLY WATERED GOING TO PLANTS REQUIRING WATER LESS FREQUENTLY.

THEREFORE, THE PRESENT ARRANGEMENT RESULTS IN AN ASSEMBLY WITH UNIQUE CHARACTERISTICS, OBTAINED FROM AN APPROPRIATE MANUFACTURING DESIGN CONCEPT.

SINCE SAID CONSTRUCTIVE ARRANGEMENT SHOWS THE BEAUTY AND ORNAMENTAL VERSATILITY OF PLANTS, OCCUPYING ONLY LIMITED SPACE, IT IS POSSIBLE TO USE VEGETAL DECORATION WITH A WIDE RANGE OF SPECIES AND KINDS OF PLANTS AND FLOWERS, APPROPRIATELY ORNAMENTING AMBIENCES WITH RESTRICTED INTERNAL SPACE, ALSO MAKING USE OF BEAMS, COLUMNS AND WALLS WITH NARROW OR SMALL DIMENSIONS.

PREFERABLY CONCEIVED IN BLACK COLOR AND APPLIED TO DULY WATERPROOFED SURFACES, ALSO IN BLACK COLOR, THE ASSEMBLY IS DISCREET, NON REFLEXIVE AND ALMOST IMPERCEPTIBLE WHEN THE VASES ARE PLACED WITH LESS SPACING.

THEREFORE, THE PRESENT ASSEMBLY FOR VERTICAL GARDENS HAS BEEN DESIGNED AIMING TO EMPLOY THE LOWEST POSSIBLE NUMBER OF PARTS, CONVENIENTLY CONFIGURED AND ARRANGED TO PERFORM ITS FUNCTIONS WITH UNIQUE EFFICIENCY AND VERSATILITY.

THE PRESENT INVENTION PRESENTS A PRACTICAL AND INNOVATIVE IMPROVEMENT IN A SUPPORT FOR PLANT DECORATION, DEVELOPED ACCORDING TO THE STATE OF THE ART, THUS ALLOWING A WIDELY VARIETY OF USES.

ITS INNOVATIVE SHAPE ALLOWS TO REACH AN EXCELLENT FUNCTIONAL LEVEL, OFFERING HIGH DURABILITY AND VERSATILITY, HAVING BEEN MAINLY CREATED TO PROVIDE BETTER FIXING OF THE PLANTS, MORE STABILITY OF THE VASES AGAINST WINDS AND A FREEING DISTANCE FROM THE OCCURRENCE OF HUMIDITY IN THE REGION WHERE THE BACK SCREEN IS FIXED

THE INVENTION AT ISSUE IS EXTREMELY EASILY BUILT, BEING ALSO EASILY MANUFACTURED, WITH EXCELLENT PRACTICAL AND FUNCTIONAL RESULTS, THUS OFFERING AN INNOVATIVE CONCEPTION OVER KNOWN MODELS.

PROJECTED WITH AN INNOVATIVE DESIGN, IT RESULTS IN A HARMONIC SET WITH A PECULIAR AND ESPECIALLY UNIQUE APPEARANCE, WHEREIN THE MODEL IS HIGHLIGHTED FOR ITS VERSATILITY AND EASY OF USE, BESIDES THE CONSTRUCTIVE ASPECT.

For better understanding of how the “IMPROVEMENT TO WALL-MOUNTED SET OF ORNAMENTAL PLANT POTS” as presented herewith is constituted, the attached drawings represent a preferred embodiment, are as follows:

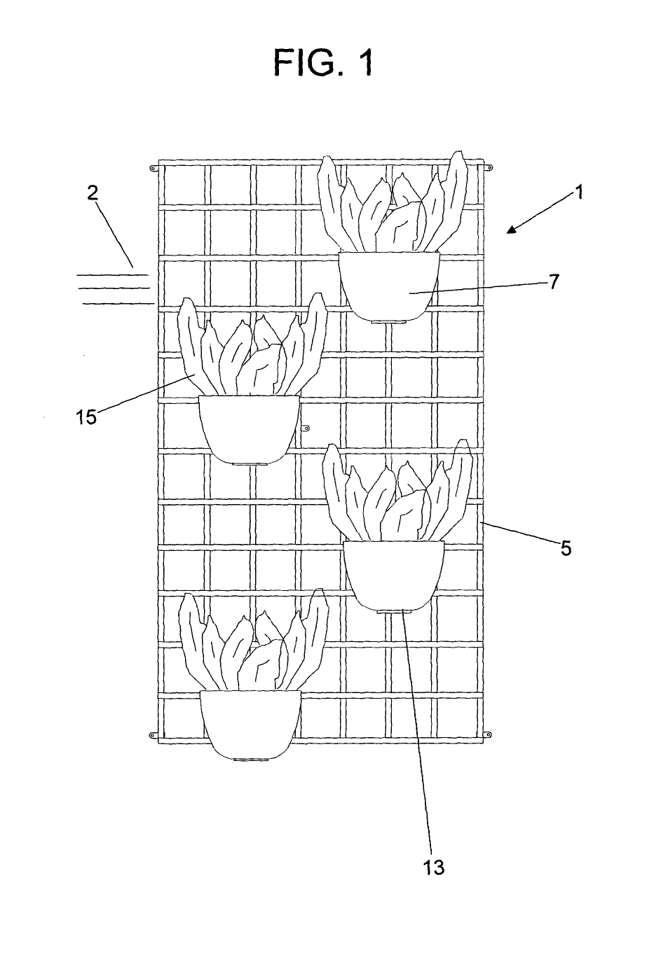

FIG. 1 shows a front view of the assembly of vertical support and vases, showing the frontal arrangement of vases containing plants;

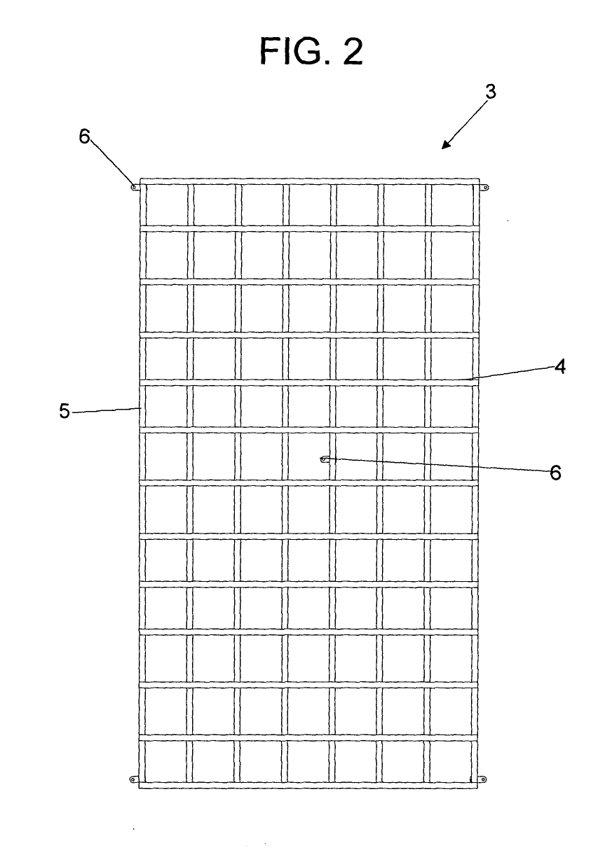

FIG. 2 shows a front view of the vertical support, showing its structure and the location of the perforated “L” shaped projections;

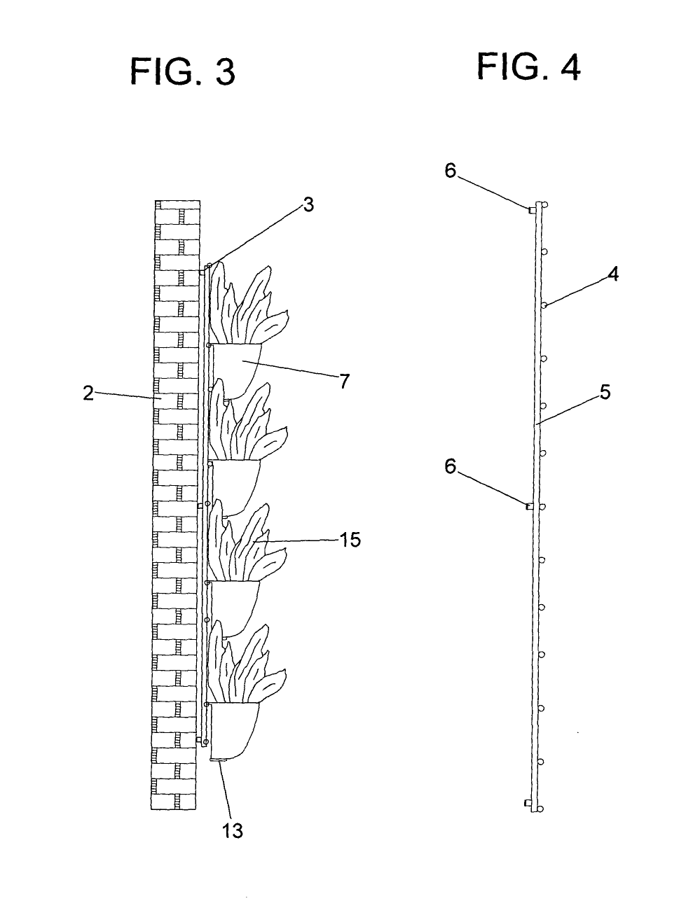

FIG. 3 shows a side view of the assembly of vertical support and vases, showing the final arrangement of vases containing plants;

FIG. 4 shows a side view of the vertical support;

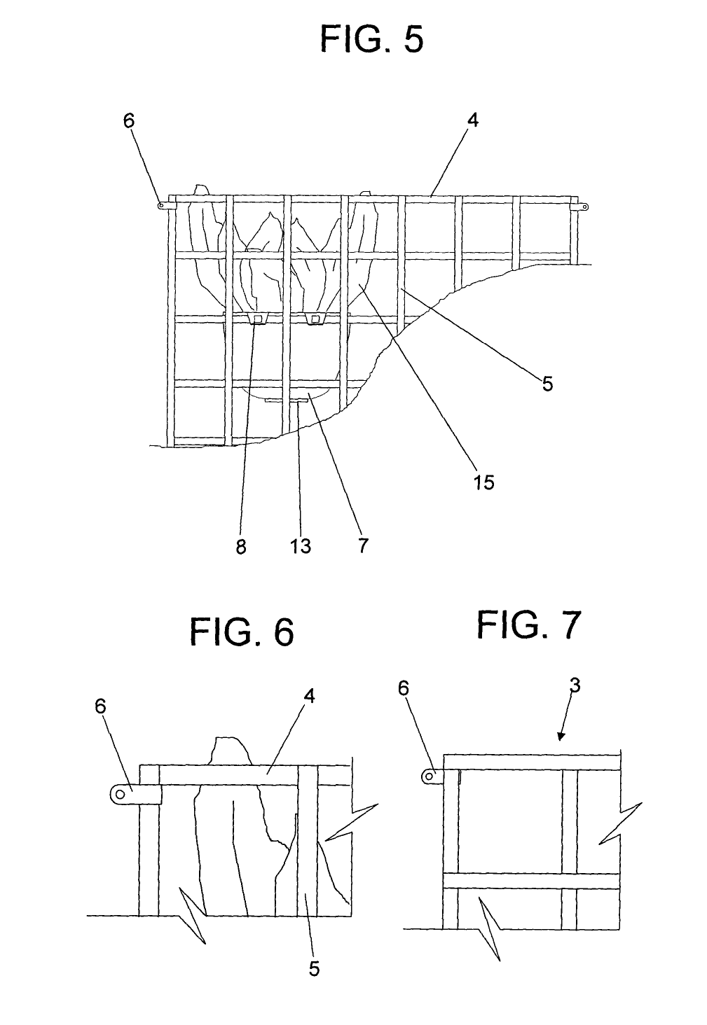

FIG. 5 shows a partial end view of the assembly of vertical support and vases, showing the fitting of “L”-shaped wings as contained in the vase over one of the horizontal rigid wires of the screen;

FIG. 6 shows an enlarged partial front view of the vertical support, showing the arrangement of one of the perforated “L” shaped projections contained in the vertex of the support;

FIG. 7 shows an enlarged partial end view of the assembly of vertical support and vases, showing one of the perforated “L” shaped projections of the support positioned in the end region of the vertical rigid wires of the screen, near the vertex;

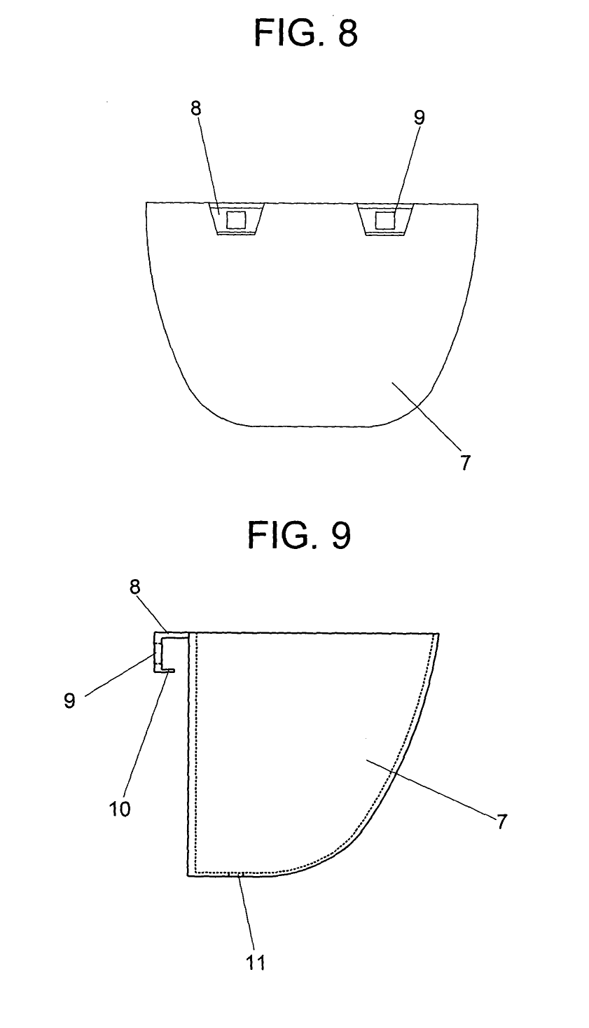

FIG. 8 shows an end view of the vase, showing fixing “L”-shaped wings;

FIG. 9 shows a side cut view of the vase, showing the fixing “L”-shaped wings;

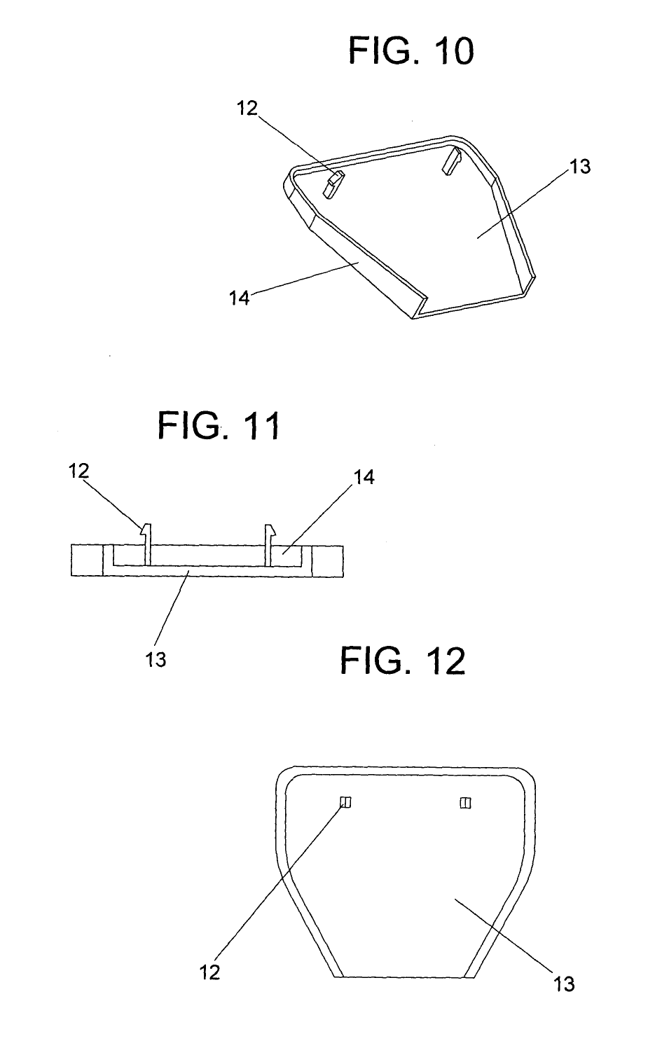

FIG. 10 shows a perspective view of the water pathway;

FIG. 11 shows an end view of the water pathway;

FIG. 12 shows an upper view of the water pathway;

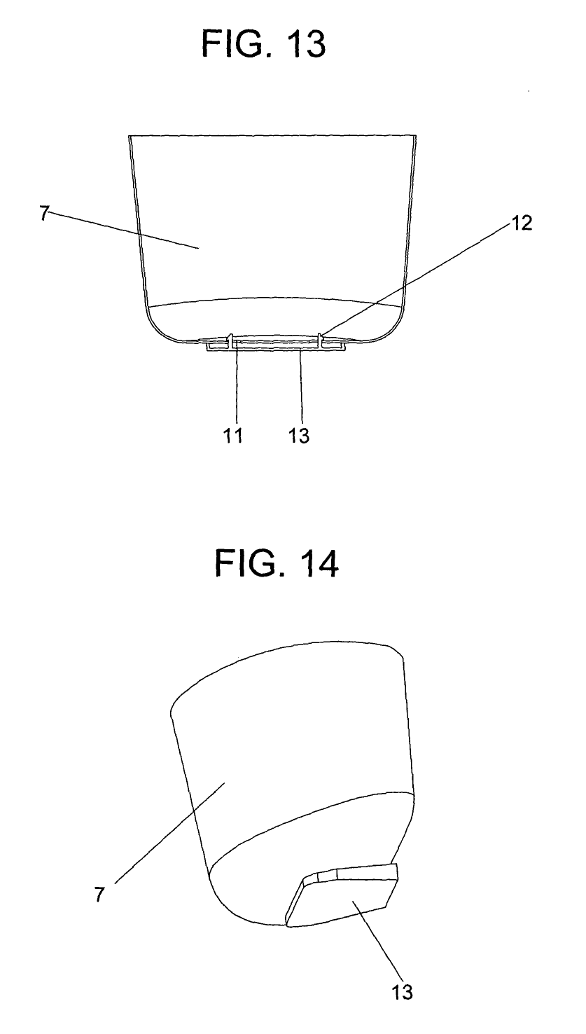

FIG. 13 shows a crosswise cut end view of the vase linked to the water pathway, showing the fitting of the support pins to the holes of the vase;

FIG. 14 shows a perspective lower side view of the vase with the water pathway.

Following the illustrations of the above listed Figures, the “IMPROVEMENT TO WALL-MOUNTED SET OF ORNAMENTAL PLANT POTS” object of the present invention, as applied to an assembly (1) which may be directly fixed to a wall (2) or a vertical flat structure by means of screws, being previously waterproofed by means of an asphalt blanket and/or polymeric mortar in black color, besides collecting elements for the exudation or wetting water.

Said assembly (1) is formed by a quadrangular screen (3) constituted by rigid horizontal (4) and vertical (5) wires of maritime grade aluminum rectangularly welded to themselves, forming two layers, subsequently covered with electrostatic painting, provided with perforated “L” projections (6), fixed to the vertexes and to the center, over the vertical rigid wires (5).

Horizontal rigid wires (4) located throughout the screen support trapezoidal/ellipsoidal vases (7), by means of one or two “L”-shaped wings (8), in solidarity to their back part, containing central rectangular holes (9) and provided with locking projections (10) at their ends.

Trapezoidal/ellipsoidal vases (7) are typically made of a polymer resistant to UVA and UVB radiation, having holes (11) at their lower ends, and inside, where support pins (12) of a trapezoidal base (13) are fitted, said base provided with rims (14) around the lateral and frontal perimeter. Said configuration has the purpose to deviate percolated water from inside the vase (7), after being sprinkled over the plants (15) therein, manually or by an automated temporized system. Said water excess projecting through the holes drips within the trapezoidal base (13), directing it to the lower end region of the vase (7), on the plane of the quadrangular screen (3), avoiding dripping and running out through its bottom.

One can therefore conclude from the above that the “IMPROVEMENT TO WALL-MOUNTED SET OF ORNAMENTAL PLANT POTS” at issue is characterized as a very useful landscaping accessory, presenting all practical and functional qualities fully justifying the requested protection.

Despite the disclosure for the above intended mode, it will be evident for the person skilled in the art that changes in the assembly may be made, not escaping from the spirit and scope of the invention, as well defined in the attached claims.

1. “IMPROVEMENT TO WALL-MOUNTED SET OF ORNAMENTAL PLANT POTS” applied to an assembly (1) fixed to a wall (2) or a vertical flat structure, being optionally previously waterproofed by means of an asphalt blanket and/or polymeric mortar, comprising exudation or wetting water collecting elements; said assembly (1) is characterized by being constituted by a screen (3), formed by horizontal (4) and vertical (5) rigid wires rectangularly fixed to one another, being provided with perforated “L”-shaped projections (6), fixed to the vertexes and the center, over the vertical rigid wires (5); horizontal rigid wires (4) located throughout the screen support trapezoidal/ellipsoidal vases (7), by means of one or two “L”-shaped wings (8), present in their back perimeter, containing central rectangular holes (9) and provided with locking projections (10) at their ends, wherein said trapezoidal/ellipsoidal vases (7) have holes (11) at their lower end and within which support pins (12) of a trapezoidal base (13) are fitted, provided with rims (14) along lateral and frontal perimeters, so as to direct the water percolated through the holes (11) of the vase (7) to the lower end region of the vase (7), on the plane of the quadrangular screen (3), after spraying over the plants (15) therein.
